(19) United States
(12) Patent Application Publication
(10) Pub. No.: US 2017/0177833 A1
(43) Pub. Date: Jun. 22, 2017

(54) SMART PLACEMENT OF DEVICES FOR IMPLICIT TRIGGERING OF FEEDBACKS RELATING TO USERS' PHYSICAL ACTIVITIES

(71) Applicant: INTEL CORPORATION, SANTA CLARA, CA (US)

(72) Inventors: ERIC LEWALLEN, Portland, OR (US); MANAN GOEL, Hillsboro, OR (US); SAURIN SHAH, Portland, OR (US); BRIAN W. BRAMLETT, Portland, OR (US)

(73) Assignee: INTEL CORPORATION, SANTA CLARA, CA (US)

(21) Appl. No.: 14/978,951

(22) Filed: Dec. 22, 2015

(51) Int. Cl. G06F 19/00; G09B 19/00

(52) U.S. Cl. CPC G06F 19/3481; G09B 19/00

(57) ABSTRACT

A mechanism is described for facilitating smart placement of devices for implicit triggering of feedbacks relating to users' physical activities according to one embodiment. A method of embodiments, as described herein, includes detecting scanning, in real-time, of a body of a user during one or more physical activities being by the user, where scanning is performed by one or more sensors placed in one or more items located within proximity of the user. The method may further include receiving data from the one or more sensors, where the data includes biometric data relating to the user. The method may further include forming a feedback based on processing of the biometric data, and communicating, in real-time, the feedback using an object or one or more feedback devices.

### FIELD

Embodiments described herein generally relate to computers. More particularly, embodiments relate to facilitating smart placement of devices for implicit triggering of feedbacks relating to users' physical activities.

### BACKGROUND

Conventional techniques do not provide for real-time biometric feedback to users during physical activities. Most physical activities (e.g., yoga, gymnastics, weight lifting, etc.) do not allow for carrying of computing devices (e.g., mobile computers, such as smartphones, tablet computers, etc.) during performance of those activities; in some cases, even when allowed, the presence of such computing devices can be disturbing and distracting not only to the user carrying the computing device, but also to other users participating in a group activity, such as yoga.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a wireless powering and tracking mechanism according to one embodiment.

FIG. 2 illustrates a wireless powering and tracking mechanism according to one embodiment.

FIG. 3A illustrates a use-case scenario according to one embodiment

FIG. 3B illustrates a use-case scenarios according to one embodiment.

FIG. 4 illustrates a method for facilitating wireless powering and tracking of passive objects according to one embodiment.

FIG. 5 illustrates computer environment suitable for implementing embodiments of the present disclosure according to one embodiment.

FIG. 6 illustrates an embodiment of a computing environment capable of supporting the operations discussed throughout this document.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for smart placement of components (e.g., sensors, sensory array) and/or devices (e.g., computing devices) for detecting and monitoring of body positions and/or movements of users to detect real-time biometric data and offer real-time feedbacks using one or more techniques, such as manipulating studio lights, sound, etc. In one embodiment, such real-time feedbacks may include (without limitation) ambient, environmental feedbacks offered in one or more forms, such as light patterns or sounds based on data captured using body-worn sensors, etc. Further, one or more forms of such feedbacks may include (without limitation) music, sound, pictures, movies, animation, text, speech, movements of objects, chanting of mantras, flashing or glowing of lights, and/or the like.

For example, such feedback may be provided for a single user or directed at an entire group or room full of people, where aggregated biometric data (e.g., breathing rate, breathing depth, balance, proper form, body balancing data, body form statistics, proper alignment information, depth of poses, aptness or success rate of postures or asanas, etc.) is appropriately relayed, in real-time, to the single user and/or the group of users.

In some embodiments, one or more sensors may be smartly placed as part of one or more items within proximity of the participating user, where the proximity refers to a predetermined area covered by or within access of one or more proximity networks, such as near-field communication network, Bluetooth, etc. One or more such items may include one or more clothing items or attire worn on the body of the user, a mat (e.g., yoga mat), an exercise floor (e.g., gymnastic floor), a playing field (e.g., basketball court), a bathtub, a swimming pool, and/or the like.

Embodiments further provide for a novel technique for facilitating coaching feedbacks to users, such as in case of yoga, a yogi may act in a role that could describe the yogi as a “Yoga Disc Jockey (DJ)” having the goal of creating a dramatic experience for their class of yoga participants. For example, the yogi may curate music and manually adjust light settings to create moods and flow, where, in one embodiment, both of which may be dynamically modified based on the biometric signals corresponding to class participants. Other coaching techniques my include breathing, turning, posturing, aligning, balancing, and/or the like.

Embodiments further provide for performing post-activity analysis of biometric data using one or more computers (such as a cloud server computer over a cloud network) for obtaining post-activity feedbacks and sharing such feedbacks with trainers, yogis, doctors, nurses, teachers, colleagues, friends, family, etc., using one or more sharing techniques over one or more networks so that the users may appropriately receive medical attention, train at home, track their progress, etc. Further, these post-activity feedbacks may provide visualized presentations of one or more of (without limitations) activity timelines, health statistics, training aims, medical analysis, weight-loss patterns, food intake data, goals and schedules, etc., to one or more users including a yogi, a trainer, a coach, a doctor, a nurse, a friend, a family member, and/or the like

It is contemplated that embodiments are not limited to any particular physical activity; however, for the sake of brevity and clarify, yoga is discussed as an example throughout this document. It is further contemplated and to be noted that embodiments are not limited to any particular number and type of software applications, application services, customized settings, etc., or any particular number and type of computing devices, networks, deployment details, etc.; however, for the sake of brevity and clarity, throughout this document, references are made to certain physical activities, sensory array, software applications, user preferences, customized settings, mobile computers (e.g., smartphones, tablet computers, etc.), communication medium or networks (e.g., cloud network, the Internet, proximity network, Bluetooth, etc.), etc., but that embodiments are not limited as such.

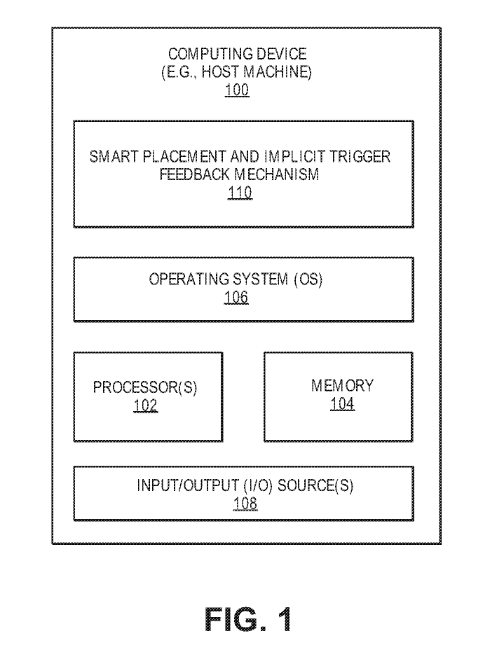

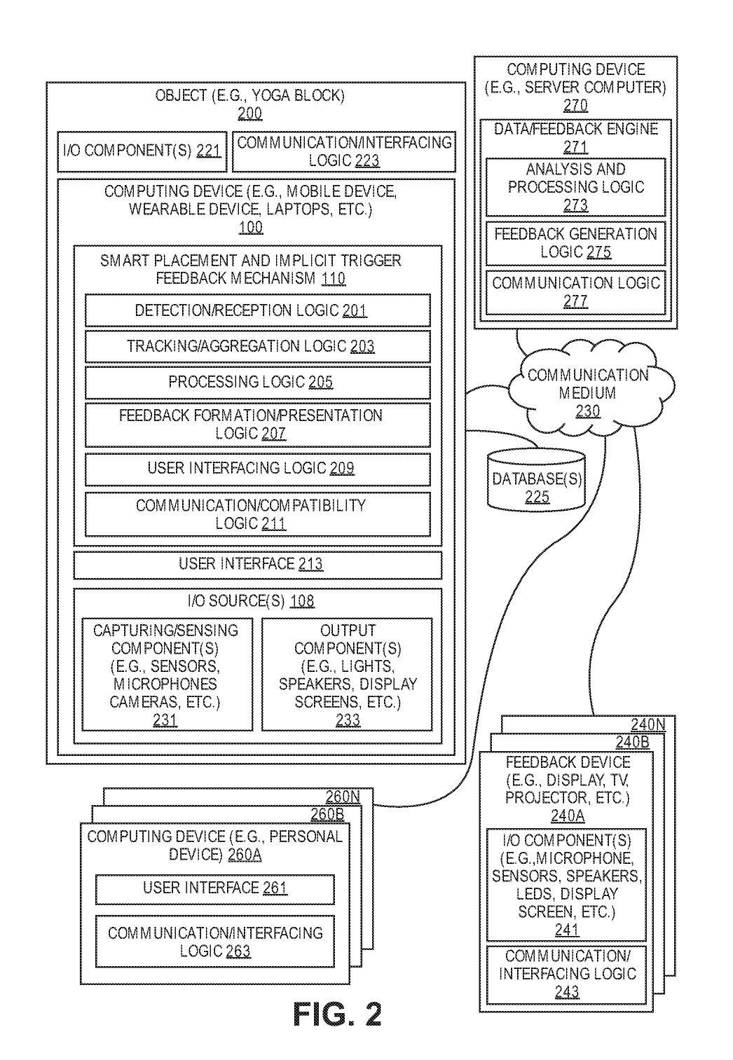

FIG. 1 illustrates a computing device 100 employing a smart placement and implicit trigger feedback mechanism 110 according to one embodiment. Computing device 100 serves as a host machine for hosting smart placement and implicit trigger feedback mechanism (“smart feedback mechanism”) 110 that includes any number and type of components, as illustrated in FIG. 2, to facilitate detection and transmission of feedback to one or more users based on smart placement of one or more computing devices, such as computing device 100, and detection of users' body positions and movements.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, such as Google® glass™, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates a smart placement and implicit trigger feedback mechanism 110 according to one embodiment. In one embodiment, smart feedback mechanism 110 may include any number and type of components, such as (without limitation): detection/reception logic 201; tracking/aggregation logic 203; processing logic 205; feedback formation/presentation logic 207; user interface logic 209; and communication/compatibility logic 211. Computing device (hereinafter referred to as “primary device”) 100 further provides user interface 215 as facilitated by user interface logic 211.

In one embodiment, primary device 100 may be placed within or hosted by object 200, such as a yoga block, including any object or item to serve to camouflage, conceal, and hold primary device 100 so that the overall ambiance or environment is not disturbed or compromised. For example, during certain activities, such as yoga, meditation, etc., the ambiance, the environment, the overall placement of things, etc., can play a significant role in helping participants achieve their goals. In one embodiment, object 200, such as a yoga block, may not only serve to camouflage and hold primary device 100, but also provide to serve its own inherent usages, such as offering support, stability, balance, etc., to help with pose, alignment, strength, etc., or simply be an added part of the ambiance.

Moreover, as illustrated, object 200 may be used as a feedback device, in addition or alternative to feedback devices 290A-N, and thus, object 200 may include or host one or more I/O component(s) 221 (e.g., microphones, sensors, detectors, cameras, LEDs, lights, speakers, display screens, projectors, etc.) to accept inputs, such as biometric data, from primary device 100 and provide outputs, such as feedback (e.g., glowing lights, synchronized flashing lights, pictures, videos, sounds, music, audio messages, etc.), as facilitated by communication/interfacing logic 223.

Primary device 100 is further shown as hosting I/O source(s) 108 having capturing/sensing component(s) 231 and output component(s) 233. In one embodiment, capturing/sensing components 231 may include sensors, microphones (e.g., ultrasound microphones), cameras (e.g., two-dimensional (2D) cameras, three-dimensional (3D) cameras, infrared (IR) cameras, depth-sensing cameras, etc.), scanners (e.g., radio-frequency identification (RFID) scanners, near-field communication (NFC) scanners, etc.), etc. Similarly, output components 233 may include microphones, light-emitting diodes (LEDs), speakers, display screens/devices, projectors, etc. Primary device 100 further provides user interface

In one embodiment, any number and type of wireless placement sensors or tags, etc., such as placement sensors 250, may be communicatively coupled with primary device 100, such as any number and type of placement sensors 250 may be worn on the body by a user (e.g., yoga participant), placed in a location, such as pressure sensor in a yoga mat (that can detect the user standing, sitting, or exercising on the mat), etc., to detect the user's body position, movement, temperature, other biometric readings, etc., that can then be communicated to primary device 100 over communication medium 230, such as a proximity network, the Internet, etc.

In some embodiments, computing device (hereinafter referred to as “secondary device”) 270 (e.g., server computer) may be employed to perform additional and/or complex and/or resource-consuming data processing for of the data collected using placement sensors 250 and/or primary device 100 at the location. For example, secondary device 270 may be a server computer, such as a cloud-based server, that is remotely located and communicatively coupled to primary device 100 over communication medium 230 (e.g., cloud network). In another embodiment, secondary device 270 may be a local device in or around the area of primary device 100, such as in the same room or another room in the same building, etc. In yet another embodiment, secondary device 270 may be a relatively smaller device, such as desktop computer, a laptop computer, etc., that is capable of receiving some or all of the aggregated data from primary device 100 (e.g., smartphone, tablet computer, wearable smart device, etc.) to perform additional computations and provide results in one or more formats (e.g., report, graphs, charts, tables, etc.) for the user. As illustrated, secondary device 270 may include data/feedback engine 271 including analysis and processing logic 273, feedback generation logic 275, and communication logic 277.

In one embodiment, other computing devices, such as computing devices 260A, 260B, 260N, may also be in communication with primary device 100. Computing devices (hereinafter referred to as “personal devices”) 260A-N (e.g., smart wearable devices, Internet of Things (IoT) devices, smartphones, tablet computers, laptop computers, desktop computers, etc.) may belong to one or more third-party users (e.g., coaches, trainers, doctors, friends, family, etc.) with whom one or more primary users may wish to share their data, such as biometric data, fitness data, etc., over communication medium 230 (e.g., Internet) using one or more communication applications (e.g., email, short messaging service (SMS), instant messaging (IM), social networking website, personal website, etc.). For example, personal device 260A may include user interface 261 (e.g., website, mobile application-based user interface, etc.) and communication/interfacing logic 263.

In one embodiment, yet there may be additional devices, such as feedback devices 240A, 240B, 240C, in communication with primary device 100 over communication medium 230 to be used for providing and sharing one or more forms of feedback, such as flashing lights, playing music, chanting mantras, displaying visuals, etc. For example, feedback devices 290A-B may include I/O component(s) 241, such as (without limitations) LEDs, lights, microphones, sensors, cameras, speakers, display screens, projectors, etc., and communication/interfacing logic 243 to facilitate communication with primary device 100. In some embodiments, feedback devices 240A-N may include (without limitation) computing devices, music players, sound machines, lighting devices, television sets, display or projection devices, etc.

Primary device 100 may be further in communication with one or more data sources, repositories, databases, etc., such as database(s) 225, storing and maintaining any amount and type of data/metadata, such as aggregated biometric data, feedback data, historical data, historical patterns, user preferences, user profiles, data identification and other information, and/or the like.

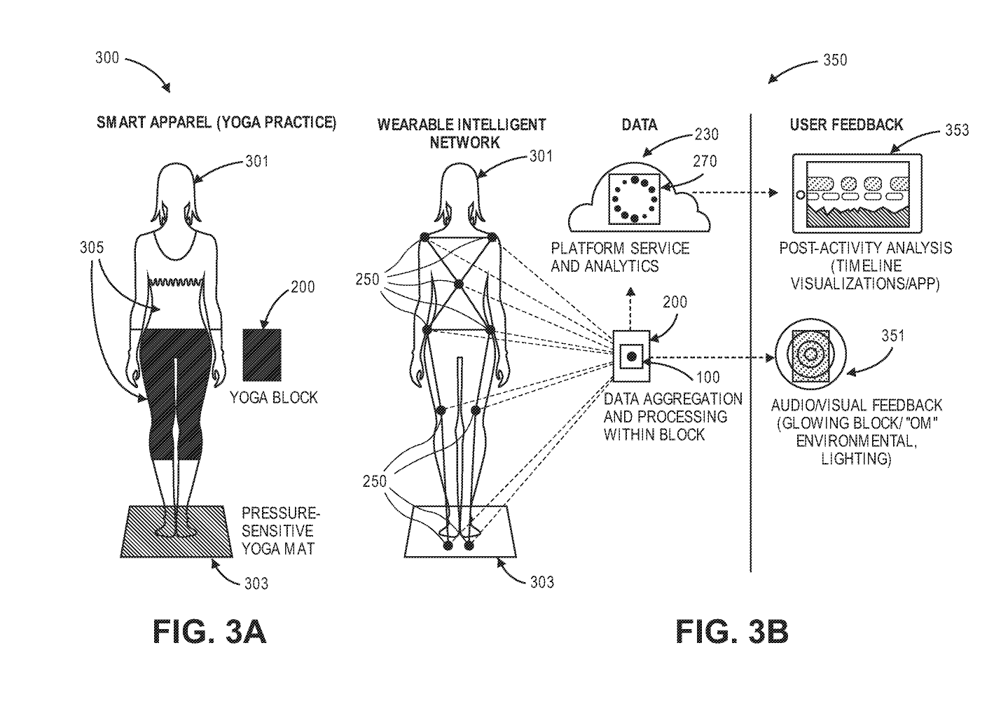

As a use-case scenario, for example, a user, such as yoga participant, may wear any number and type of placements sensors 250 at various spots their body, as illustrated with reference to FIG. 3B. In some embodiment, placement sensors 250 may be embedded in other items, such as pressure sensors in a yoga mat, etc. In one embodiment, these placement sensors 250 continue to detect and monitor the user's body moves and positions in various forms, such as standing on the mat, sitting on the mat, taking deep breadths, balancing on one foot, etc. For example, placement sensors 250 may detect and take biometric readings of the user's body based on movements, positions, etc., and communicate the biometric data on to primary device 100 over communication medium 230 (e.g., proximity network, Internet, etc.).

At smart feedback mechanism 110, this biometric data is detected or received by detection/reception logic 201 from one or more placement sensors 250, over communication medium 230, where this biometric data is then forwarded on to tracking/aggregation logic 203 for tracking and aggregation purposes. For example, in case of yoga, tracking/aggregation logic 203 may continue to track the user's breathing pattern, balance in posturing, etc., and aggregates the tracked information for further processing by processing logic 205.

In one embodiment, processing logic 205 may then be triggered to perform one or more processes relating to the aggregated and tracked biometric data, where such processes include (without limitation) sorting of the biometric data (e.g., by user, activity, date, etc.), comparing with historical data (e.g., user progress, medical conditions, inactivity gaps, etc.), evaluating relevant metadata (e.g., user's age, gender, frequency of activities, etc.), analyzing with regard to the corresponding user and each activity (e.g., breathing, balancing, posturing, etc.), evaluating coaching instructions (e.g., real-time or past instructions from coaches, trainers, doctors, etc.), and/or the like.

In one embodiment, this processing of the biometric data also helps determine what time of feedback issued. For example, in case of a group activity, the feedback may include an ambient feedback, such as playing music to help focus, chanting a mantra to help with breathing, glowing LED lights to indicate breathing patterns, forms, alignment, etc., (e.g., indicating 7 chakras of yoga, such as lights being red, orange, yellow, green, blue, indigo, and violet, etc.), playing ocean sounds, showing a video, playing audio of real-time instructions from coach/yogi, and/or the like, as provided by one or more I/O components, such as I/O component(s) 241, of one or more feedback devices 240A-N, such as feedback device 240A, as facilitated by communication/interfacing logic 243 and communication/compatibility logic 213.

Similarly, the aforementioned feedbacks may be offered to individual users on a more customized or personalized level through a personal or intimidate device, such as object 200. In one embodiment, a customized feedback may be based on a set of biometric data relating to an individual user having access to object 200 (e.g., yoga block), where, for example, this customized feedback may include playing personalized breathing instructions as, for example, whispered by the user's personal coach, glowing lights indicating the 7 chakras as they specifically relate to the user, and/or the like. Further, in some embodiments, customized feedbacks may also be based on users' profiles and preferences, such as a user may not want to hear a particular genre of music, while another user may find videos to be distracting, and yet another user may prefer chanting mantra over flashing lights, etc. It is contemplated that such a feedback may be provided using one or more I/O component(s) 221 of object 200 as facilitated by communication/interfacing logic 223 and communication/compatibility logic 213, wherein I/O component(s) 221 may include one or more of (without limitations) LED lights, speakers, display screens, projectors, microphones, sensors, cameras, etc.

Referring back to smart feedback mechanism 110, one the relevant feedback data has been processed by processing logic 209, any processing results are then forwarded on to feedback formation/presentation logic 207. For example, once processing logic 209 has processed the data and determined an appropriate type of feedback for the user or each user in case of a group of users, feedback formation/presentation logic 207 then selects that type of feedback (e.g., real-time instructions, glowing lights, certain music, etc.) and prepares the feedback to having relevant contents (e.g., instructions, sequence or color of glowing lights, etc.) so it may then be presented to the user(s).

For example, once a feedback is prepared for the user by feedback formation/presentation logic 207, it presents that feedback to communication/compatibility logic 211 to communicate the feedback to one or more devices, by default or as provided in the user's profile/preferences, so that the one or more devices, such as object 200, feedback device 240A, etc., may provide the feedback to the user. In some cases, such as per the user preferences, the feedback may be transmitted over to one or more personal devices 260A-N so that the feedback may be shared with one or more users (e.g., coach, trainer, doctor, family, friends, etc.) of the one or more of personal devices 260A-N as facilitated by communication/interfacing logic 263. Further, communication/interfacing logic 263 may also be used to present the feedback (such as in the format selected by the user) to the one or more users, such as a trainer, via one or more interfaces, such as user interface 261, at their corresponding personal devices 260A-N, such as personal device 260A.

In one embodiment, some or all of the biometric data obtained through placement sensors 250 and as facilitated by primary device 100 may be outsourced or offloaded to secondary device 270 for processing. In one embodiment, it is contemplated that in some embodiments, primary device 100 may be a small device, such as smartphone, with limited resources, battery life, processing or computational capabilities for high-bandwidth or complex computations, etc., and in such cases, various data processing tasks may be outsourced to a larger cloud-based server computer, such as secondary device 270, over communication medium 230, such a cloud network. In another embodiment, real-time processing may be performed at primary device 100, while additional or post-activity analysis may be performed at secondary device 270. For example, the user may wish to receive a post-activity report to determine the overall progress or performance or, in some cases, share with personal trainer or doctor for fitness purposes or health reasons, respectively.

For example, some of the data, such as biometric data, may be communicated from primary device 100 to secondary device 270, as facilitated by communication/compatibility logic 211 and communication logic 277, where the communicated data is received at data/feedback engine 271. The data may then be analyzed and processed by analysis and processing logic 273 and subsequently, feedback generation logic 275 may receive this analyzed and processed data and generate a feedback based on the analyzed and processed data. For example, as previously discussed, a personalized post-analysis feedback may be generated by feedback generation logic 275, where this feedback may then be communicated back to primary device 100 for the user's benefit and/or shared with one or more personal devices 260A-N to provide the feedback to one or more users (e.g., trainers, doctors, friends, family, etc.) having access to the one or more personal devices 260A-N. For example, such a post-analysis feedback may include one or more of (without limitation) a timeline of user activities, a chart/graphical visualization of user progress, a table of user's body dimensions or weight, a list of coach instructions or compliments or criticisms, etc., which may be provided through user interface 213 and/or user interface 263, such as a websites, a mobile application-based interface, etc.

Personal device 100 may include I/O source(s) 108 having capturing/sensing components 231 and output components 233, where, for example, capturing/sensing components 231 may include (without limitation) 2D cameras, 3D cameras, depth-sensing cameras (e.g., Intel® RealSense™ camera, etc.), sensor array, microphone array, etc., while, output components 233 may include (without limitation) display screens, display/projection areas, projectors, speakers, etc. In some embodiments, object 200, feedback devices 240A-B, personal device 260A-N may include the same or similar I/O components, such as I/O component(s) 221, 241, etc., as I/O source(s) 108.

Personal device 100 may be further in communication with one or more repositories or data sources or databases, such as database(s) 225, to obtain, communicate, store, and maintain any amount and type of data (e.g., user biometric data, user health data, user fitness data, user and/or device preferences, user and/or device profiles, authentication/verification data, other data and/or metadata relating to users and/or devices, such as object 200, personal devices 260A-N, feedback devices 240A-N, etc., recommendations, predictions, data tables, data maps, media, metadata, templates, real-time data, historical contents, user and/or device identification tags and other information, resources, policies, criteria, rules, regulations, upgrades, etc.).

In some embodiments, communication medium 230 may include any number and type of communication channels or networks, such as cloud network, the Internet, intranet, Internet of Things (“IoT”), proximity network, such as Bluetooth, RFID, NFC, Body Area Network (BAN), etc. It is contemplated that embodiments are not limited to any particular number or type of computing devices, services or resources, databases, networks, etc.

Capturing/sensing components 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing components 231 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing components 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing components 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing components 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 231 may further include voice recognition devices, photo recognition devices, facial and other body recognition components, voice-to-text conversion components, etc.

Similarly, output components 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output components 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios; however, the yoga-related case scenario shown with respect to FIGS. 3A-3B, is discussed throughout this document for the sake of brevity and clarity, but it is to be noted that embodiments are not limited as such. Further, throughout this document, “user” may refer to someone having access to one or more devices and/or objects (e.g., primary device 100, object 200, personal devices 260A-N, feedback devices 240A-N, placement sensors 250, etc.) and may be referenced interchangeably with “person”, “individual”, “human”, “him”, “her”, “child”, “adult”, “participant”, “player”, “gamer”, “developer”, programmer”, and/or the like.

Communication/compatibility logic 211 may be used to facilitate dynamic communication and compatibility between various devices, such as primary device 100, secondary device 270, personal devices 260A-N, feedback devices 240A-N, object 200, placement sensors 250, database(s) 225, communication medium 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as primary device 100. In another example, “logic” may refer to or include a hardware component that is capable of being physically installed along with or as part of one or more system hardware elements, such as an application processor, a graphics processor, etc., of a computing device, such as primary device 100. In yet another embodiment, “logic” may refer to or include a firmware component that is capable of being part of system firmware, such as firmware of an application processor or a graphics processor, etc., of a computing device, such as primary device 100.

Further, any use of a particular brand, word, term, phrase, name, and/or acronym, such as “body”, “position”, “movement”, “implicit trigger”, “feedback” “yoga”, “placement sensor”, “feedback device”, “primary device”, “secondary device”, personal device”, “tracking”, “aggregating”, “RFID”, “NFC”, “BAN”, “LED”, “sensor”, “camera”, “microphone”, “device”, “identification”, “ID”, “secured”, “privacy”, “user”, “user profile”, “user preference”, “user”, “sender”, “receiver”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from smart feedback mechanism 110 to facilitate various embodiments including adding, removing, and/or enhancing certain features. For brevity, clarity, and ease of understanding of smart feedback mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a use-case scenario 300 according to one embodiment. As an initial matter, for brevity, many of the details discussed with reference to the previous FIGS. 1-2 may not be discussed or repeated hereafter. Further, it is contemplated and to be noted that embodiments are not limited to any particular architectural placement, system setup, use-case scenarios, such as use-case scenario 300.

In the illustrated embodiment, use-case scenario 300 relates to yoga-related activities, such as user 301 is shown as a yoga participant, wearing yoga apparel or attire 305, standing on a yoga mat, such as pressure-sensitive yoga mat 303, and having a yoga block, such as object 200, nearby. For example, as previously discussed with regard to FIG. 2, yoga mat 303 may include a number of pressure sensors to sense various body positions and movements of user 301, such as standing, sitting, posturing, leaning, balancing, etc., on yoga mat 303 or even being absent from yoga mat 303. Similarly, in one embodiment, as aforementioned with respect to FIG. 2, object 200 may include a yoga block which may be capable of hosting a computing device, such as primary device 100 as illustrated in FIG. 2, and serving as a feedback device to provide one or more forms (e.g., glowing LED lights, sounds, music, visuals, etc.) of feedbacks as described with reference to FIG. 2.

FIG. 3B illustrates a use-case scenario 350 according to one embodiment. As an initial matter, for brevity, many of the details discussed with reference to the previous FIGS. 1-3A may not be discussed or repeated hereafter. Further, it is contemplated and to be noted that embodiments are not limited to any particular architectural placement, system setup, use-case scenarios, such as use-case scenario 350.

The illustrated use-case scenario 350 is an extension of use-case scenario 300 of FIG. 3A, where, in one embodiment, any number and type of placement sensors 250 may be used to form an intelligent wireless network. For example, a couple of placement sensors 250 (e.g., pressure sensors) may be placed in yoga mat 303, while multiple placement sensors 250 may be placed on various body parts of user 301, such as knees, hips, stomach, shoulders, etc., using one or more clothing items of attire 305. For example, one or more placement sensors 250 may be placed in a clothing item of attire 305 which user 301 can wear to have the one or more placement sensors 250 get in touch or within proximity of the corresponding one or more body parts of user 301 so that various measurements and readings, such as biometric readings, relating to user 301 may be taken by sensing or detecting changing movements, positions, etc., of the one or more parts of the body of user 301.

In one embodiment, user data, such as biometric readings, may be communicated on to primary device 100 placed within object 200 to process the data and offer one or more feedbacks 351 (e.g., audio feedback, visual feedback, glowing block (e.g., object 200), chanting of a mantra (e.g., “OM”), environment or ambient changes, such as flashing lights, playing music, etc., and/or the like) through one or more devices, such as object 200, feedback devices 240A-N of FIG. 2, etc.

Similarly, in one embodiment, user data, such as biometric readings, may be sent over to another larger server computing device, such as secondary device 270, over communication medium 230, such as a cloud network, for alternative or supplemental post-activity analysis and processing of the data. For example, secondary device 270 may be used to perform post-activity analysis for providing additional post-activity feedback to the user, where such post-activity feedback may include timelines, visualization graphs or charts, tables, etc. For example, such post-analysis feedbacks may be offered to the user and/or one or more other users through one or more computing devices, such as personal devices 260A-N, primary device 100, etc.

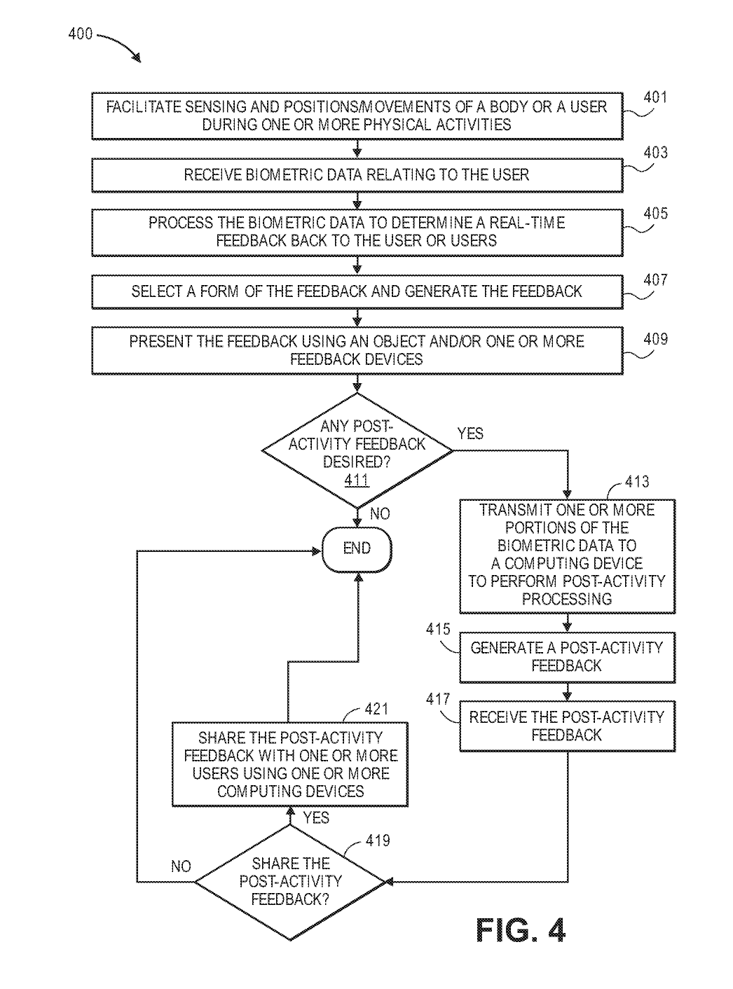

FIG. 4 illustrates a method 400 for facilitating smart feedback relating to user activities according to one embodiment. Method 400 may be performed by processing logic that may comprise hardware (e.g., circuitry, dedicated logic, programmable logic, etc.), software (such as instructions run on a processing device), or a combination thereof, as facilitated by smart feedback mechanism 110 of FIG. 1. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3B may not be discussed or repeated hereafter.

Method 400 begins at block 401 with facilitating one or more sensors to sense position and/or movements relating to a body of user during one or more activities, such as yoga, sports, physical therapy, physical fitness training, etc., to detect biometric readings relating to the user during the one or more activities. At block 403, this biometric data is then received at a computing device from the one or more sensors for further processing. For example, the computing device may be part of or placed within an object, such as a yoga block. In one embodiment, the one or more sensors may be placed at one or more locations on the user's body (such as by placing it in the user's clothing) and/or within proximity of the user, such as in a yoga mat. Further, this biometric data may be continuously detected by the one or more sensors and received and gathered at the computing device.

At block 405, the biometric data is processed at the computing device to determine a feedback to be provided back to the user (e.g., yoga participant, etc.) and/or other users (e.g., yoga participants, sports team, therapy group, etc.). At block 407, the feedback is selected and formed for presentation. At block 409, the feedback is presented by communicating it to one or more feedback devices and/or the object for the benefit of the user and/or a group of users (e.g., yoga participants, sports team, therapy group, etc.). In one embodiment, the feedback may include one or more of (without limitation) audio feedback (e.g., instructions, chanting, music, etc.), video feedback (e.g., movie, stream, animation, etc.), lights feedback (e.g., glowing of the object, flashing of lights, etc.), and/or the like. Further, in one embodiment, the feedback may be an ambient feedback that is shared by an entire group of individuals, such as yoga participants, etc., or, in another embodiment, the feedback may be a customized and personalized feedback that is communicated only to the user.

At block 411, in one embodiment, a determination is made as to whether any post-activity feedback is desired. If not, method 400 ends at block 423. If yes, at block 413, the biometric data is outsourced over to a server computer over a network, such as a cloud network, to perform supplemental or alternative post-activity analysis and processing of the biometric data. At block 415, a post-activity feedback is generated based on the post-activity analysis and processing of the biometric data. At block 417, the post-activity feedback (e.g., tables, charts, graphs, timelines, etc.) is received at the computing device to be provided to the user.

At block 419, in one embodiment, another determination is made as to whether any of the post-activity feedback is to be shared with other users (e.g., coaches, trainers, doctors, friends, family, etc., or other participant users, teammates, etc.). If not, method 400 ends at block 423. If yes, at block 421, any or all of the post-activity feedback is shared with one or more users by communicating, over one or more networks (e.g., Internet, proximity network, etc.), the post-activity feedback to one or more computing device accessible to the one or more users. At block 423, method 400 ends.

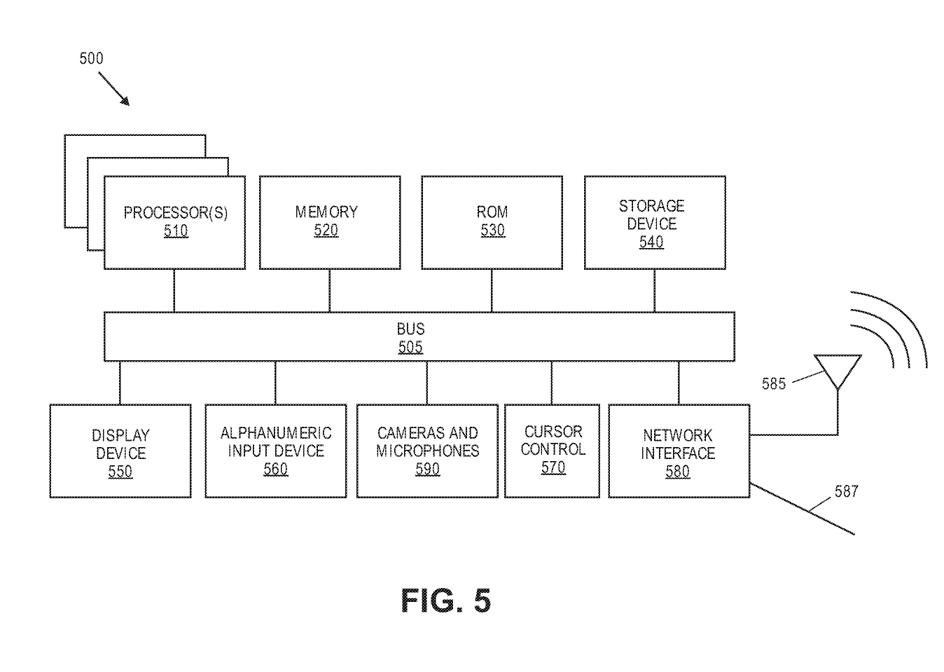

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or) other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

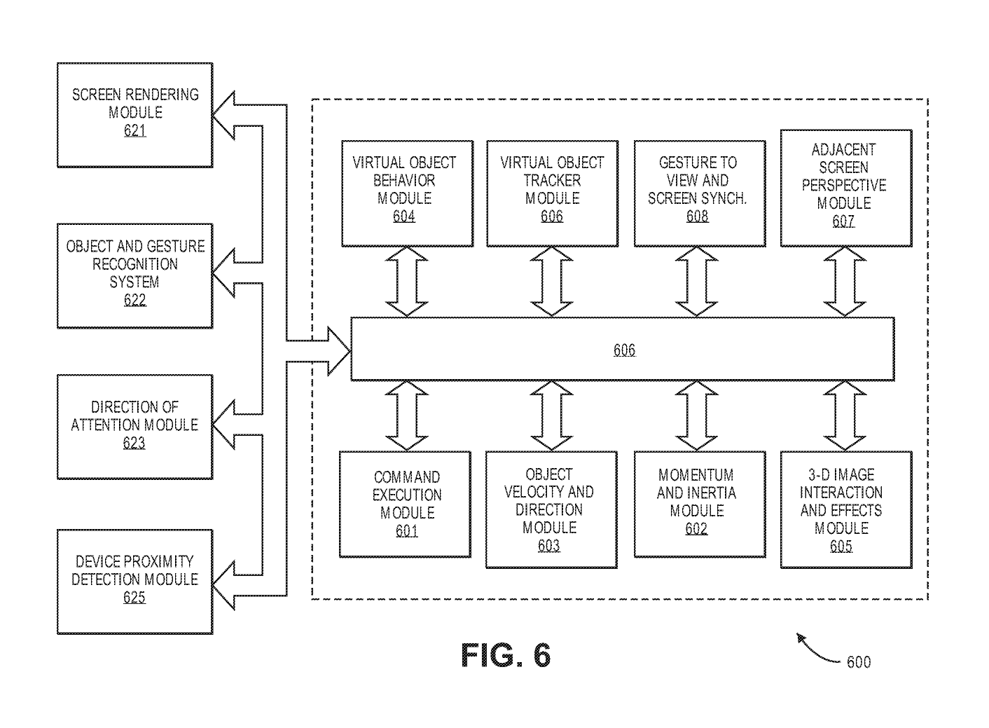

FIG. 6 illustrates an embodiment of a computing environment 600 capable of supporting the operations discussed above. The modules and systems can be implemented in a variety of different hardware architectures and form factors including that shown in FIG. 4.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate smart placement of devices for implicit triggering of feedbacks relating to users' physical activities, comprising: one or more capturing/sensing components to detect scanning, in real-time, of a body of a user during one or more physical activities being by the user, wherein scanning is performed by one or more sensors placed in one or more items located within proximity of the user; detection/reception logic to receive data from the one or more sensors, wherein the data includes biometric data relating to the user; feedback formation and presentation logic to form a feedback based on processing of the biometric data; and communication/compatibility logic to communicate, in real-time, the feedback using an object or one or more feedback devices.

Example 2 includes the subject matter of Example 1, wherein the biometric data comprises one or more of breathing rate, breathing depth, balancing data, body form statistics, alignment information, and posture success rate.

Example 3 includes the subject matter of Example 1, wherein the one or more items comprise at least one of one or more clothing items on the body of the user, a mat, an exercise floor, a playing field, a bathtub, or a swimming pool, wherein the proximity refers to a predetermined area covered by one or more proximity networks.

Example 4 includes the subject matter of Example 1, wherein the object to host or encompass the apparatus, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

Example 5 includes the subject matter of Example 1, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

Example 6 includes the subject matter of Example 1, further comprising tracking and aggregation logic to continuously track the real-time scanning of the body of the user during the one or more physical activities, wherein the tracking and aggregation logic is further to aggregate the data received from the one or more sensors.

Example 7 includes the subject matter of Example 1 or 6, further comprising processing logic to perform real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights.

Example 8 includes the subject matter of Example 7, wherein the processing logic is further to transmit the one or more portions of the data to a server computer to perform post-activity processing of the one or more portions of the data, wherein the detection/reception logic is further to receive a post-activity feedback from the server computer over a network including a cloud network or the Internet, wherein the communication/compatibility logic is further to communicate the post-activity feedback to the user via a user interface of the apparatus or another apparatus or to one or more users via one or more user interfaces of the one or more computing devices over one or more networks.

Example 9 includes the subject matter of Example 8, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

Some embodiments pertain to Example 10 that includes a method for facilitating smart placement of devices for implicit triggering of feedbacks relating to users' physical activities, comprising: detecting scanning, in real-time, of a body of a user during one or more physical activities being by the user, wherein scanning is performed by one or more sensors of a computing device placed in one or more items located within proximity of the user; receiving data from the one or more sensors, wherein the data includes biometric data relating to the user; forming a feedback based on processing of the biometric data; and communicating, in real-time, the feedback using an object or one or more feedback devices.

Example 11 includes the subject matter of Example 10, wherein the biometric data comprises one or more of breathing rate, breathing depth, balancing data, body form statistics, alignment information, and posture success rate.

Example 12 includes the subject matter of Example 10, wherein the one or more items comprise at least one of one or more clothing items on the body of the user, a mat, an exercise floor, a playing field, a bathtub, or a swimming pool, wherein the proximity refers to a predetermined area covered by one or more proximity networks.

Example 13 includes the subject matter of Example 10, wherein the object to host or encompass the computing device, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

Example 14 includes the subject matter of Example 10, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

Example 15 includes the subject matter of Example 10, further comprising continuously tracking the real-time scanning of the body of the user during the one or more physical activities, wherein tracking includes aggregating the data received from the one or more sensors.

Example 16 includes the subject matter of Example 10 or 15, further comprising performing real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights.

Example 17 includes the subject matter of Example 16, further comprising transmitting the one or more portions of the data to a server computer to perform post-activity processing of the one or more portions of the data, wherein detecting includes receiving a post-activity feedback from the server computer over a network including a cloud network or the Internet, wherein communicating includes communicating the post-activity feedback to the user via a user interface of the computing device or another computing device or to one or more users via one or more user interfaces of the one or more computing devices over one or more networks.

Example 18 includes the subject matter of Example 17, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

Some embodiments pertain to Example 19 includes a system comprising a storage device having instructions, and a processor to execute the instructions to facilitate a mechanism to: detecting scanning, in real-time, of a body of a user during one or more physical activities being by the user, wherein scanning is performed by one or more sensors of a computing device placed in one or more items located within proximity of the user; receiving data from the one or more sensors, wherein the data includes biometric data relating to the user; forming a feedback based on processing of the biometric data; and communicating, in real-time, the feedback using an object or one or more feedback devices.

Example 20 includes the subject matter of Example 19, wherein the biometric data comprises one or more of breathing rate, breathing depth, balancing data, body form statistics, alignment information, and posture success rate.

Example 21 includes the subject matter of Example 19, wherein the one or more items comprise at least one of one or more clothing items on the body of the user, a mat, an exercise floor, a playing field, a bathtub, or a swimming pool, wherein the proximity refers to a predetermined area covered by one or more proximity networks.

Example 22 includes the subject matter of Example 19, wherein the object to host or encompass the computing device, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

Example 23 includes the subject matter of Example 19, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

Example 24 includes the subject matter of Example 19, wherein the mechanism is further to continuously track the real-time scanning of the body of the user during the one or more physical activities, wherein tracking includes aggregating the data received from the one or more sensors.

Example 25 includes the subject matter of Example 19 or 24, wherein the mechanism is further to perform real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights.

Example 26 includes the subject matter of Example 25, wherein the mechanism is further to transmit the one or more portions of the data to a server computer to perform post-activity processing of the one or more portions of the data, wherein detecting includes receiving a post-activity feedback from the server computer over a network including a cloud network or the Internet, wherein communicating includes communicating the post-activity feedback to the user via a user interface of the computing device or another computing device or to one or more users via one or more user interfaces of the one or more computing devices over one or more networks.

Example 27 includes the subject matter of Example 26, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

Some embodiments pertain to Example 28 includes an apparatus comprising: means for detecting scanning, in real-time, of a body of a user during one or more physical activities being by the user, wherein scanning is performed by one or more sensors of the apparatus placed in one or more items located within proximity of the user; means for receiving data from the one or more sensors, wherein the data includes biometric data relating to the user; means for forming a feedback based on processing of the biometric data; and means for communicating, in real-time, the feedback using an object or one or more feedback devices.

Example 29 includes the subject matter of Example 28, wherein the biometric data comprises one or more of breathing rate, breathing depth, balancing data, body form statistics, alignment information, and posture success rate.

Example 30 includes the subject matter of Example 28, wherein the one or more items comprise at least one of one or more clothing items on the body of the user, a mat, an exercise floor, a playing field, a bathtub, or a swimming pool, wherein the proximity refers to a predetermined area covered by one or more proximity networks.

Example 31 includes the subject matter of Example 28, wherein the object to host or encompass the apparatus, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

Example 32 includes the subject matter of Example 28, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

Example 33 includes the subject matter of Example 28, further comprising means for continuously tracking the real-time scanning of the body of the user during the one or more physical activities, wherein the means for tracking includes means for aggregating the data received from the one or more sensors.

Example 34 includes the subject matter of Example 28 or 33, further comprising means for performing real-time processing of the data to prepare for the feedback, wherein the real-time processing includes means for selecting one or more forms of the feedback, wherein the one or more forms including music, sound, pictures, movies, animation, text, speech, movement of objects, chanting of mantras, and flashing or glowing of lights.

Example 35 includes the subject matter of Example 34, further comprising means for transmitting the one or more portions of the data to a server computer to perform post-activity processing of the one or more portions of the data, wherein the means for detecting includes means for receiving a post-activity feedback from the server computer over a network including a cloud network or the Internet, wherein the means for communicating includes means for communicating the post-activity feedback to the user via a user interface of the apparatus or a computing device or to one or more users via one or more user interfaces of the one or more computing devices over one or more networks.

Example 36 includes the subject matter of Example 35, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
one or more capturing/sensing components to detect scanning, in real-time, of a body of a user during one or more physical activities being by the user, wherein scanning is performed by one or more sensors placed in one or more items located within proximity of the user;
detection/reception logic to receive data from the one or more sensors, wherein the data includes biometric data relating to the user;
feedback formation and presentation logic to form a feedback based on processing of the biometric data; and
communication/compatibility logic to communicate, in real-time, the feedback using an object or one or more feedback devices.

2. The apparatus of claim 1, wherein the biometric data comprises one or more of breathing rate, breathing depth, balancing data, body form statistics, alignment information, and posture success rate.

3. The apparatus of claim 1, wherein the one or more items comprise at least one of one or more clothing items on the body of the user, a mat, an exercise floor, a playing field, a bathtub, or a swimming pool, wherein the proximity refers to a predetermined area covered by one or more proximity networks.

4. The apparatus of claim 1, wherein the object to host or encompass the apparatus, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

5. The apparatus of claim 1, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

6. The apparatus of claim 1, further comprising tracking and aggregation logic to continuously track the real-time scanning of the body of the user during the one or more physical activities, wherein the tracking and aggregation logic is further to aggregate the data received from the one or more sensors.

7. The apparatus of claim 1, further comprising processing logic to perform real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights.

8. The apparatus of claim 7, wherein the processing logic is further to transmit the one or more portions of the data to a server computer to perform post-activity processing of the one or more portions of the data, wherein the detection/reception logic is further to receive a post-activity feedback from the server computer over a network including a cloud network or the Internet, wherein the communication/compatibility logic is further to communicate the post-activity feedback to the user via a user interface of the apparatus or another apparatus or to one or more users via one or more user interfaces of the one or more computing devices over one or more networks.

9. The apparatus of claim 8, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

10. A method comprising:
detecting scanning, in real-time, of a body of a user during one or more physical activities being by the user, wherein scanning is performed by one or more sensors of a computing device placed in one or more items located within proximity of the user;
receiving data from the one or more sensors, wherein the data includes biometric data relating to the user;
forming a feedback based on processing of the biometric data; and
communicating, in real-time, the feedback using an object or one or more feedback devices.

11. The method of claim 10, wherein the biometric data comprises one or more of breathing rate, breathing depth, balancing data, body form statistics, alignment information, and posture success rate.

12. The method of claim 10, wherein the one or more items comprise at least one of one or more clothing items on the body of the user, a mat, an exercise floor, a playing field, a bathtub, or a swimming pool, wherein the proximity refers to a predetermined area covered by one or more proximity networks.

13. The method of claim 10, wherein the object to host or encompass the computing device, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

14. The method of claim 10, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

15. The method of claim 10, further comprising continuously tracking the real-time scanning of the body of the user during the one or more physical activities, wherein tracking includes aggregating the data received from the one or more sensors.

16. The method of claim 10, further comprising performing real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights.

17. The method of claim 16, further comprising transmitting the one or more portions of the data to a server computer to perform post-activity processing of the one or more portions of the data, wherein detecting includes receiving a post-activity feedback from the server computer over a network including a cloud network or the Internet, wherein communicating includes communicating the post-activity feedback to the user via a user interface of the computing device or another computing device or to one or more users via one or more user interfaces of the one or more computing devices over one or more networks.

18. The method of claim 17, wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.

19. At least one machine-readable storage medium comprising a plurality of instructions stored thereon, the instructions when executed on a computing device, cause the computing device to:
detect scanning, in real-time, of a body of a user during one or more physical activities being by the user, wherein scanning is performed by one or more sensors of the computing device placed in one or more items located within proximity of the user;
receive data from the one or more sensors, wherein the data includes biometric data relating to the user;
form a feedback based on processing of the biometric data; and
communicate, in real-time, the feedback using an object or one or more feedback devices.

20. The machine-readable storage medium of claim 19, wherein the biometric data comprises one or more of breathing rate, breathing depth, balancing data, body form statistics, alignment information, and posture success rate.

21. The machine-readable storage medium of claim 19, wherein the one or more items comprise at least one of one or more clothing items on the body of the user, a mat, an exercise floor, a playing field, a bathtub, or a swimming pool, wherein the proximity refers to a predetermined area covered by one or more proximity networks.

22. The machine-readable storage medium of claim 19, wherein the object to host or encompass the computing device, wherein the object includes a yoga block, a baseball base, a swimming tube, and a seat, wherein the feedback includes glowing of one or more lights embedded in the object indicating an activity of or a message to the user, wherein glowing includes changing colors of the object based on the one or more physical activities, wherein at least one of the one or more physical activities includes seven chakras in yoga reflected by one or more colors of the one or more lights, wherein the one or more colors include red, orange, yellow, green, blue, indigo, and violet.

23. The machine-readable storage medium of claim 19, wherein the one or more feedback devices include one or more of computing devices, music players, sound machines, television sets, lights, display devices, and projection screens, wherein the feedback is communicated to the user via the one or more feedback devices, wherein the feedback includes instructions to the user from a coach of the one or more physical activities.

24. The machine-readable storage medium of claim 19, wherein the computing device is further to continuously track the real-time scanning of the body of the user during the one or more physical activities, wherein tracking includes aggregating the data received from the one or more sensors.

25. The machine-readable storage medium of claim 19, wherein the computing device is further to:
perform real-time processing of the data to prepare for the feedback, wherein processing includes selecting one or more forms of the feedback, wherein the one or more forms including music, sound, pictures, movies, animation, text, speech, movement of objects, chanting of mantras, and flashing or glowing of lights; and
transmit the one or more portions of the data to a server computer to perform post-activity processing of the one or more portions of the data, wherein detecting includes receiving a post-activity feedback from the server computer over a network including a cloud network or the Internet, wherein communicating includes communicating the post-activity feedback to the user via a user interface of the computing device or another computing device or to one or more users via one or more user interfaces of the one or more computing devices over one or more networks,
wherein the post-activity feedback comprises a visualized presentation of one or more of activity timelines, health statistics, training aims, medical analysis, weight-loss patterns, food intake data, and goals and schedules, wherein the one or more users comprise at least one of a yogi, a trainer, a coach, a doctor, a nurse, a friend, and a family member.
